(19) United States
(12) Patent Application Publication
(10) Pub. No.: US 2026/0111594 A1
(43) Pub. Date: Apr. 23, 2026

(54) DECENTRALIZED IDENTITY MANAGEMENT APPARATUS, DECENTRALIZED IDENTITY MANAGEMENT SYSTEM, DECENTRALIZED IDENTITY MANAGEMENT METHOD, AND DECENTRALIZED IDENTITY MANAGEMENT STORAGE MEDIUM

(71) Applicant: NEC Corporation, Minato-ku, Tokyo (JP)

(72) Inventors: Junpei TADA, Irving, TX (US); Terutaka UCHIDA, Irving, TX (US); Kannan Veeranan GANDHI, Irving, TX (US); Anwar Uliah MUHAMMAD, Irving, TX (US); Srinivasa Rao VIKKURTHI, Irving, TX (US)

(73) Assignee: NEC Corporation, Minato-ku, Tokyo (JP)

(21) Appl. No.: 19/117,685

(22) PCT Filed: Oct. 26, 2023
(86) PCT No.: PCT/JP2023/038755

§ 371 Date: Apr. 2, 2025

Related U.S. Application Data
(60) Provisional application No. 63/419,581, filed on Oct. 26, 2022.

(51) Int. Cl. G06F 21/62; H04L 9/32

(52) U.S. Cl. CPC G06F 21/6245; H04L 9/3249; H04L 9/3268

(57) ABSTRACT

An apparatus including a memory and a processor. The processor transmits a request for creating a decentralized identification (DID) information to an external device; and receives the DID information along with a digital token credential and an user certificate from the external device. The request includes an image of the DID subject and a public key of the apparatus.

This application claims the benefit of U.S. Provisional Patent Application Ser. No. 63/419,581, filed on Oct. 26, 2022, which is hereby incorporated by reference in its entirety.

### TECHNICAL FIELD

The disclosure relates to a decentralized identity management apparatus, decentralized identity management system, decentralized identity management method and decentralized identity management storage medium. More particularly, it relates to a decentralized identity management apparatus, decentralized identity management system, decentralized identity management method and decentralized identity management storage medium for facilitating mobile, interactive and/or contact-free operations in an authentication process that can be used in a variety of facilities, such as an airport for example. However, the disclosure is not limited to the authentication process in the airport. For instance, one or more aspects of the disclosure may be applied in other facilities or environments.

### RELATED ART

Currently, the world is experiencing a pandemic with the COVID-19 corona virus causing extensive social distancing measures to be taken. With these measures and concern for contracting the virus, there is an urgent and widespread need to limit contact with other people while still engaging in activities that necessitate being in close proximity to strangers. Accordingly, there is a need for users who use public or private facilities and follow the required process flows to perform the required authentication procedures with a minimum of contact with publically accessible devices.

Moreover, in view of a large number of facilities and vendors that require authentication before providing service or products, a user's private information necessary for authentication may be stored at various places. As such, there is an increased threat to security of the user's private information. As such, there is a need for protecting privacy and securing online interactions such that the user's information are not compromised.

### SUMMARY

According to an aspect of the disclosure, there is provided a decentralized identity technology, also referred to as self-sovereign identity technology, which uses digital identifiers and verifiable credentials that are self-owned, independent, and enable trusted data exchange. Moreover, the decentralized identity technology may be provided as an open standards-based identity framework. According to an aspect of the disclosure, the decentralized identity technology protects privacy and secures online interactions.

According to an aspect of the disclosure, there is provided an apparatus including: a memory storing one or more instructions; and a processor configured to execute the one or more instructions to: obtain an image of a user; obtain a public key of the apparatus; transmit a request for creating a decentralized identification (DID) information to an external device; and receive the DID information along with a digital token credential and an user certificate from the external device.

The image may be a selfie image of the user.

The public key may be obtained by generating an RSA key pair.

The digital token credential may be signed by a private key of the external device.

The processor may be further configured to: transmit a document credential request to the external device; and receive a document credential from the external device.

The processor may be further configured to: create a signature by signing a credential subject and a type of document using a private key portion of an RSA key pair; assemble the document credential request with the credential subject, the type of the document, the digital token credential and a proof that comprises the signature; and transmit the document credential request to the external device.

The signature may be a JSON Web Signature (JWS).

The credential subject may include at least one of document information and an image scanned from a document.

The document may be one of a driver's license, a passport, or a vaccination card.

The processor may be further configured to: transmit a data share credential request to the external device; receive a data share credential from the external device; transmit an issue challenge request to the external device; receive a challenge from the external device; create a data share request using the data share credential and challenge; and transmit the data share request to the external device.

The data share credential request may include a credential subject, which comprises event details, and metadata corresponding to the event details.

The challenge may include an expiration time, and the challenge is associated with the DID information.

According to another aspect of the disclosure, there is provided a decentralized identity management method including: obtaining, by an electronic device, an image of a user and a public key; transmitting, by the electronic device, a request for creating a decentralized identification (DID) information to an external device; and receiving, by the electronic device, the DID information along with a digital token credential and an user certificate from the external device.

The method may further include: transmitting a document credential request to the external device; and receiving a document credential from the external device.

The method may further include: creating a signature by signing a credential subject and a type of document using a private key portion of an RSA key pair; assembling the document credential request with the credential subject, the type of the document, the digital token credential and a proof that comprises the signature; and transmitting the document credential request to the external device.

The method may further include: transmitting a data share credential request to the external device; receiving a data share credential from the external device; transmitting an issue challenge request to the external device; receiving a challenge from the external device; creating a data share request using the data share credential and challenge; and transmitting the data share request to the external device.

According to another aspect of the disclosure, there is provided a management apparatus including: a memory storing one or more instructions; and a processor configured to execute the one or more instructions to: receive a request for creating a decentralized identification (DID) information to an external device, the request including an image of a user and a public key of the external device; and transmit the DID information along with a digital token credential and an user certificate to the external device.

The processor may be further configured to: receive a document credential request to the external device, the document credential request comprising a credential subject, a type of document, the digital token credential and a proof that comprises a signature; and transmit a document credential from the external device.

The processor may be further configured to: perform verification based on the digital token credential and the credential subject; perform verification of the signature in the proof of the document credential request using a public key associated with the DID; based on a verification of the proof being successful, create the document credential with the credential subject, sign the document credential with a private key of the apparatus, and transmit the document credential to the external device.

The processor may be further configured to: receive a data share credential request from the external device; transmit a data share credential to the external device; receive an issue challenge request from the external device; transmit a challenge to the external device; receive a data share request created using the data share credential and challenge; and transmit a verification success or failure based on verification of information in the data share request.

According to another aspect of the disclosure, there is provided a decentralized identity management method including: receiving a request for creating a decentralized identification (DID) information to an external device, the request including an image of a user and a public key of the external device; and transmitting the DID information along with a digital token credential and an user certificate to the external device.

The method may further include receiving a document credential request to the external device, the document credential request comprising a credential subject, a type of document, the digital token credential and a proof that comprises a signature; and transmitting a document credential from the external device.

The method may further include performing verification based on the digital token credential and the credential subject; performing verification of the signature in the proof of the document credential request using a public key associated with the DID; based on a verification of the proof being successful, creating the document credential with the credential subject, signing the document credential with a private key of the apparatus, and transmitting the document credential to the external device.

The method may further include receiving a data share credential request from the external device; transmitting a data share credential to the external device; receiving an issue challenge request from the external device; transmitting a challenge to the external device; receiving a data share request created using the data share credential and challenge; and transmitting a verification success or failure based on verification of information in the data share request.

### BRIEF DESCRIPTION OF DRAWINGS

FIG. 1 is a schematic diagram illustrating a configuration of a decentralized identifier (DID) management system according to an example embodiment.

FIG. 2A illustrates a concept that establishes the decentralized identity management technique according to an example embodiment.

FIG. 2B illustrates a concept that establishes the decentralized identity management technique according to an example embodiment.

FIG. 2C illustrates a concept that establishes the decentralized identity management technique according to an example embodiment.

FIG. 2D illustrates a concept that establishes the decentralized identity management technique according to an example embodiment.

FIG. 3 illustrates a mobile application according to an example embodiment.

FIG. 4 is a schematic diagram illustrating a configuration of a decentralized identifier (DID) management system according another example embodiment.

FIG. 5A is a flow chart illustrating an account creation process according to an example embodiment.

FIG. 5B is a flow chart illustrating an account creation process according to another example embodiment.

FIG. 6 is a flow chart illustrating a document credential process according to an example embodiment.

FIG. 7A is a flow chart illustrating a data share process according to an example embodiment.

FIG. 7B is a flow chart illustrating a data share process according to an example embodiment.

FIG. 8A is a diagram illustrating an example of a data share process according to an example embodiment.

FIG. 8B is a diagram illustrating an example of a data share process according to an example embodiment.

FIG. 8C is a diagram illustrating an example of a data share process according to an example embodiment.

FIG. 9 illustrates a block diagram of the management apparatus according to an example embodiment.

FIG. 10 illustrates a block diagram of the mobile device according to an example embodiment.

### DESCRIPTION OF EXAMPLE EMBODIMENTS

Example embodiments will now be described below in more detail with reference to the accompanying drawings. The following detailed descriptions are provided to assist the reader in gaining a comprehensive understanding of the methods, apparatuses, and/or systems described herein. However, the example embodiment provided in the disclosure should not be considered as limiting the scope of the disclosure. Accordingly, various changes, modifications, and equivalents of the systems, apparatuses and/or methods described herein will be suggested to those of ordinary skill in the art.

The terms used in the description are intended to describe embodiments only, and shall by no means be restrictive. Unless clearly used otherwise, expressions in a singular form include a meaning of a plural form. In the present description, an expression such as “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

One or more example embodiments of the disclosure will be described below with reference to the drawings. Throughout the drawings, the same components or corresponding components are labeled with the same reference numerals, and, accordingly, the description thereof may be omitted or simplified.

According to an example embodiment, the decentralized identity, also referred to as self-sovereign identity, may use digital identifiers and verifiable credentials that are self-owned, independent, and enable trusted data exchange. The decentralized identity may be implemented as an open standards-based identity framework, and may use blockchains, distributed ledger technology, and private/public key cryptography to ensure security and privacy of user's sensitive information.

According to an example embodiment, the decentralized identity management system may be designed to augment or replace related art identity management service (IDMS) platforms that control or manage user's information in a centralized manner. According to an example embodiment, the decentralized identity management system is a system that provides for or allows a user's device, such as a mobile device, to manage and control user's digital identity and data on their own. According to an example embodiment, the decentralized identity management may have a framework that is implemented based on World Wide Web Consortium (W3C) standards. According to an example embodiment, decentralized identity management may be established based on the following concepts: (1) decentralized identifier (DID), (2) DID subject, (3) DID document, (4) verifiable credentials (VC), (5) verifiable presentation (VP) and (6) Self-Sovereign Identity (SSI) Chain of Trust. However, the disclosure is not limited thereto, and as such, according other example embodiments, one or more of these concepts may be omitted and/or other concepts may be included. Details of these concepts may be described below.

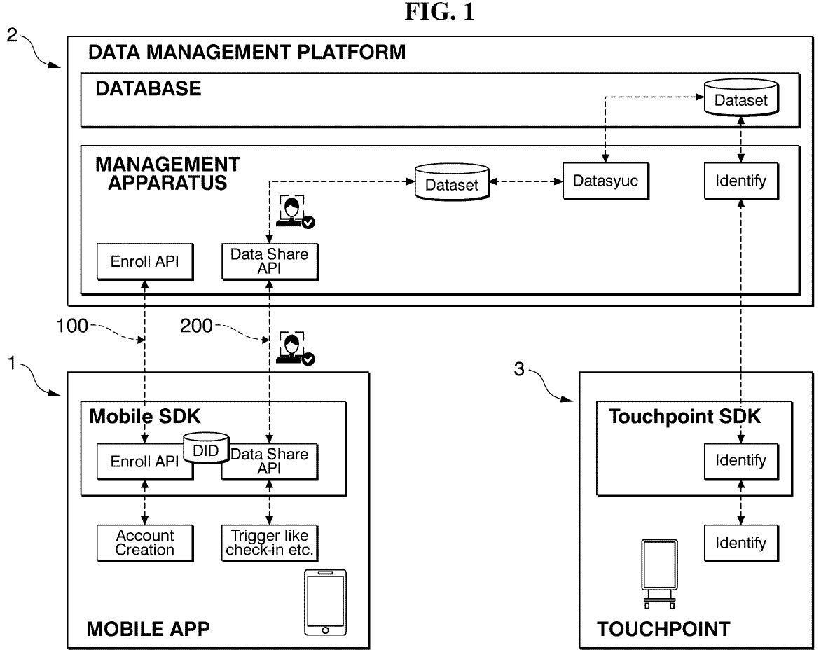

FIG. 1 is a schematic diagram illustrating a configuration of a decentralized identifier (DID) management system for facilitating an authentication process that protects privacy and provides secure online interactions.

According to an example embodiment, the DID management system include an electronic device 1 and a data management platform 2. According to an example embodiment, the electronic device may be a mobile device, such as a smart phone, a laptop, a wearable device (i.e., smart watch or smart ring), a smart card or another type of mobile electronic device. However, the disclosure is not limited thereto, and as such, according to another example embodiment, the electronic device 1 may be a desktop computer, a house appliance device, etc.

According to an example embodiment, the data management platform 2 may include a management apparatus and a database. According to an example embodiment, the management apparatus and the database may be implemented as a single device or separate devices. According to an example embodiment, the management apparatus may be a server.

According to an example embodiment, the DID management system may include a touch point device 3. However, the disclosure is not limited thereto, and as such, the touch point device 3 may be omitted.

According to an example embodiment, an account creation process 100 and a data share process 200 are illustrated with reference to FIG. 1. Here, as an example, the electronic device 2 will be referred to a mobile device. According to an example embodiment, a user of the mobile device may download a DID application and install the DID application on the mobile device. The DID application may be a DID mobile app. The mobile app may include a software development kit (SDK). According to an example embodiment, the SDK provides the ability to communicate with the other applications or devices. For example, the SDK may allow the mobile app to communicate with the data management platform through an application program interface (API).

According to an example embodiment, the mobile app may execute program codes and or instructions to create a user account with the data management platform 2 and share data with the data management platform 2 for creating verifiable document credentials and/or verifiable document presentation.

According to an example embodiment, when an account creation is selected, for example by a user, the mobile app may initiate the account creation process 100. For example, the mobile app may use a DID enroll API to start the account creation process. According to an example embodiment, the DID APIs, such as the DID enroll API may be accessed without login. Therefore, since DID APIs do not require login, the APIs are not secured, but instead are protected. According to an example embodiment, the protected APIs may be authenticated using a JSON Web Token (JWT), which is an open standard that defines a compact and self-contained way for securely transmitting information between parties as a JSON object. According to an example embodiment, the data management platform (i.e., the backend) only validates whether the DID that is part of the JWT payload exists in the system.

According to an example embodiment, during the account creation process 100, the mobile app may transmit an image and a public key to the management apparatus of the data management platform, and the management apparatus will return a digital token credential along with the DID an a user certificate. According to an example embodiment, during the account creation process 100, the user may provide an image to be included in the account creation (or enrollment) request. According to an example embodiment, the mobile app may prompt the user to take a selfie image. However, the disclosure is not limited thereto, and as such, the mobile app receive a user image in a different manner. According to an example embodiment, the selfie image may be included as a base64 String in the account creation request.

According to an example embodiment, the mobile app may include a public key with the request for enrollment. According to an example embodiment, the mobile device or the mobile app may obtain or produce the public key by generating a RSA key pair. According to an example embodiment, the RSA key pair may have key size of 2048 bits. However, the disclosure is not limited thereto. Moreover, the generating the public key from the RSK key pair may further include generating Distinguished Encoding Rules (DER) encoded bytes from public key portion of RSA key pair, generating x509EncodedKey SpecEncoded bytes from DER encoded bytes and generate Base64 encoded string from x509EncodedKey SpecEncoded bytes. Accordingly, the Base64 encoded string may be included as the public key in the account creation request along with the image of the user. However, the disclosure is not limited thereto, and as such, the public key may be obtained or produced in a different manner.

According to an example embodiment, after sending the account creation request with the image and the public key, the mobile app may receive a digital token credential along with a DID, and a user certificate.

According to an example embodiment, the management apparatus may receive the image and the public key. According to an example embodiment, the management apparatus may validate the public key and the image. After validating public key and making sure the image is a valid image, the management apparatus may generate a decentralized identifier (DID). Moreover, the management apparatus may generate a digital token, and generate a user certificate. According to an example embodiment, the digital token may include the DID, the image, a proof and a credential type. According to an example embodiment, the user certificate includes information for performing subsequent DID transactions by the mobile app. For example the user certificate may be used during the data share process 200 for creating document credentials and/or verifiable presentation.

According to an example embodiment, the management apparatus may store the DID, the public key and the user certificate. According to an example embodiment, the management apparatus may send a response, which include the DID, the user certificate and the digital token. According to an example embodiment, the response maybe returned via the account creation API. According to an example embodiment, the digital token's proof (i.e., credential) may be signed by a private key of the management apparatus. However, the disclosure is not limited thereto, and as such, the digital token's proof (i.e., credential) may be signed by a private key of an authorized third party. According to an example embodiment, the user certified may be a JSON Web Token (JWT). However, the disclosure is not limited thereto, and as such, may be implemented by another certification process. According to an example embodiment, the user certificate may never expire and may be required as bearer token in all subsequent transactions between the mobile app and the management apparatus or the digital management platform. For example, the user certificate may be included in an authorization header of an API request for calls to create verifiable document credentials and/or verifiable presentations using the DID received during the account creation process 100. However, the disclosure is not limited thereto, and as such, the user certificate may be used in another manner according to various other example embodiments.

According to an example embodiment, after the DID is generated and sent to the mobile app, the management apparatus may allow the user to digitize the identity documents by issuing a verifiable credential (VC) encapsulating all the information available on the document. According to the example embodiment, the identity document may include, but is not limited to, a driver's license, a passport, and a vaccination card. According to an example embodiment, the management apparatus may rely on mobile app to extract and/or verify the data from scanned document and issue verifiable credentials for the driver's license, the passport, and the vaccination card.

According to an example embodiment, document credentials may be required based on a tenant's Identity Assurance Level (IAL) requirements. According to an example embodiment, a tenant may be an entity that is providing a particular service for the user. For example, the tenant may be an airline, an amusement park, or a restaurant. However, the disclosure is not limited thereto, and as such, the tenant may be from various industries that provide service to a user and require authentication of the user. In order to provide the service, the user must be verified through some sort of authentication. According to an example embodiment, the IAL requirements may include the following: (IAL1) only requires image and no document credential is not required, (IAL2) image and at least one document credential is required, and (IAL3) image and two document credentials are required.

According to an example, the document credential creation process may include the mobile app creating a JSON Web Signature (JWS) by signing a credential subject and a type of document using a private key portion of the RSA key pair. According to an example embodiment, the credential subject may include document information and cropped image scanned from the document. Also, the document information may be information extracted from the document.

According to an example embodiment, the mobile app may assemble the request payload for the document credential with the credential subject, the type of the document, the digital token credential and a proof that includes the JWS and send the request payload to the management apparatus. Upon receiving the request payload, the management apparatus may perform validation on the data in the request payload and issue a document credential.

According to an example embodiment, the request payload for document credential may be similar to the payload for creating the account, except the request payload may be signed with the private key that is paired with the public key shared in payload for creating the payload, and the JWS is added in the proof of the request. According to an example embodiment, the digital token credential may also be included in the request payload for the document credential, since the management apparatus may perform a one to one (1:1) verification with the selfie image (from the account creation process) and the document's cropped image. In additional to the image verification, the management apparatus may also verify the signature (JWS) in the proof of the request using the public key associated with the DID. After the proof verification is successfully completed, the management apparatus may create the document credential with the same credential subject, and sign it with a private key of the management apparatus, and return the document credential in a response to the mobile app.

According to an example embodiment, after the account creation process and the data credential process, data sharing maybe selected. According to an example embodiment, the data share process 200 may be triggered by an event, such as a check-in event or may be triggered by a user input. However, the disclosure is not limited thereto, and as such various other events may trigger the data share process 200.

According to an example embodiment, the data share process 200 may include creating a data share credential, fetching a challenge from the management apparatus and creating the data share request. According to an example embodiment, the data share credential may be a temporary credential that provides event details that subsequently helps the management apparatus (or the backend) to resolve a targeted dataset. According to an example embodiment, the event details may be tenant specific configurations. According to an example embodiment, the mobile app may store keys of the event details and the corresponding metadata in a local configuration of the mobile app. However, the disclosure is not limited thereto, and as such, the keys of the event details and/or the corresponding metadata may be stored in a different manner.

According to an example embodiment, the data share credential request payload may include a credential subject, which may include event details, and metadata. According to an example embodiment, the credential subject may include DID.

According to an example embodiment, upon receiving the data share credential request payload, the management apparatus may perform credential subject validation. Moreover, the management apparatus may look up public key associated with the DID included in the data share credential request payload subject and verify signature. If the signature is verified as valid, the management apparatus may sign the credential subject using a private key of the management apparatus. However, if the signature is not verified, the management apparatus may return and error message.

According to an example embodiment, after obtaining the data share credential, the mobile app may send a request to the management apparatus to issue a challenge. The request may include a DID for which the challenge is desired. According to an example embodiment, the management apparatus may issue a challenge and send to the mobile app. According to an example embodiment, the challenge may be JWT with a limited expiry, and the challenge may be associated with the DID provided in the request for issuance of the challenge. According to an example embodiment, the management apparatus may issue a challenge with an expiration to avoid replay attacks, and as such the challenge may be mandatory to be part of proof in the data share request.

According to an example embodiment, the mobile app may create the data share request using the data share credentials and challenge. According to an example embodiment, the data share request may also be referred to as a verifiable presentation (VP). According to an example, the VP may include the mobile app creating a JSON Web Signature (JWS), to be included in the proof, by signing the digital token, data share credential, one or more document credentials, and a credential subject and a type of document using a private key portion of the RSA key pair. According to an example embodiment, the mobile app may include the challenge in the proof. Thereafter, the mobile app may invoke a data share API and send a payload including verifiable presentation, and user certificate. However, the disclosure is not limited thereto, and as such, the payload may further include a target system, which may be a third party system for resolving the verifiable presentation.

According to an example embodiment, upon receiving the data share request payload, the management apparatus may validate the challenge, verify the signature, and verify if ID in the credential subject matches with the verifiable presentation proof. If any of these verifications/validations fail, an error message is transmitted to the mobile app. According to an example embodiment, the data share request payload may be stored in a local database of the management apparatus.

According to an example embodiment, the management apparatus may share the credential subject (including face image) with the target system. According to an example embodiment, the target system may be identity management service of the management apparatus. However, the disclosure is not limited thereto, and as such, the target system may be a third party system. According to an example embodiment, a target dataset will be resolved by comparing the system/tenant configuration of the target system and the payload shared by mobile app.

According to an example embodiment, by creating the DID and other verifiable credentials, the user is able to share data in a tamper-evident presentation encoded in such a way that authorship of the data can be trusted after a process of cryptographic verification. Moreover, the DID system provides a domain agnostic implementation that allows data share request to be resolved by the targeted dataset(s) as per tenant configuration.

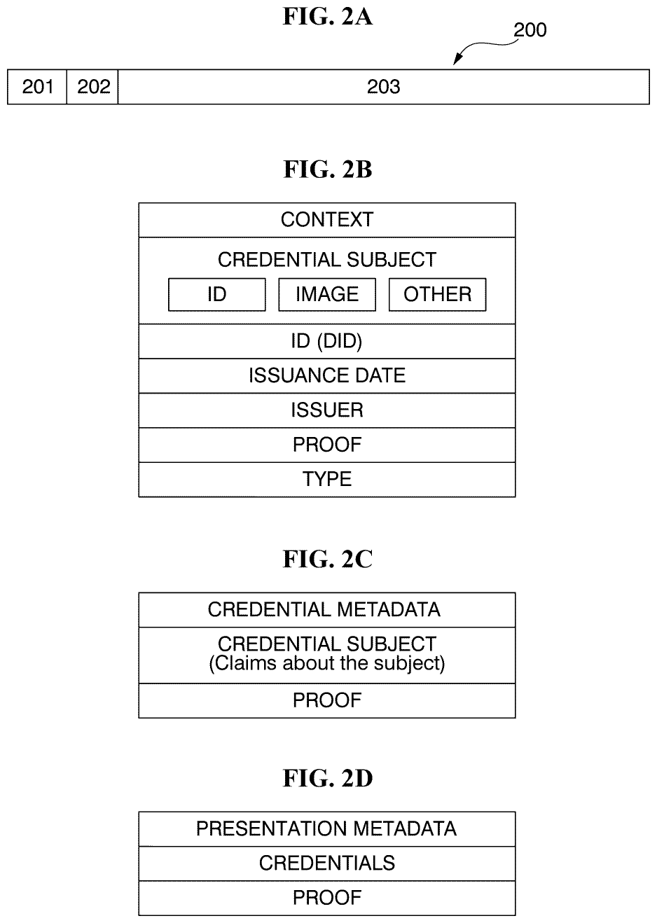

FIGS. 2A-2D illustrate concepts that establish the decentralized identity management technique. For instance, the concepts may include (1) decentralized identifier (DID), (2) DID subject, (3) DID document, (4) verifiable credentials (VC), (5) verifiable presentation (VP) and (6) Self-Sovereign Identity (SSI) Chain of Trust.

According to an example embodiment, the decentralized identifiers (DID) are globally unique identifiers that may exhibit the following four characteristics: decentralized, persistent, cryptographically verifiable and cryptographically resolvable. According to an example, embodiment, the DID 200 may include three parts as illustrated in FIG. 2A. For instance, the DID 200 may include a scheme identifier 201, a method identifier 202 and a method specific identifier 203. According to an example embodiment, the DID scheme identifier 201 may be a Uniform Resource Identifier (URI) scheme identifier. According to the DID method identifier 202 may identify a mechanism by which a particular type of DID and its associated DID document are created, resolved, updated, and deactivated. According to an example embodiment, DID Method-Specific Identifier 203 may be Unique Identifier.

According to an example embodiment, a subject of a DID is the entity identified by the DID. The DID subject may also be the DID controller. According to an example embodiment, a subject of a DID is not limited to a person, and as such, may be further include a group, an organization, a thing, or a concept. According to an example embodiment, a DID document may be a set of data describing the DID subject. According to an example embodiment, the data describing the subject may include mechanisms, such as cryptographic public keys, that the DID subject can use to authenticate itself and prove its association with the DID. An example of a DID document is illustrated in FIG. 2B.

FIG. 2C illustrates a structure of verifiable credential (VC) or a document credential according to an example embodiment. According to an example embodiment, a verifiable credential can represent all the same information that a physical credential (e.g., Driver License/Passport) represents. However, the addition of technologies, such as digital signatures, makes verifiable credentials more tamper-evident and more trustworthy than their physical counterparts. According to an example embodiment, the verifiable credential may include credential metadata, credential subject and proof.

FIG. 2D illustrates a structure of verifiable presentation (VP) or data share according to an example embodiment. According to an example embodiment, a verifiable presentation is a tamper-evident presentation of verifiable credentials that is encoded in such a way that authorship of the data can be trusted after a process of cryptographic verification. According to an example embodiment, the verifiable presentation may include presentation metadata, credentials and proof.

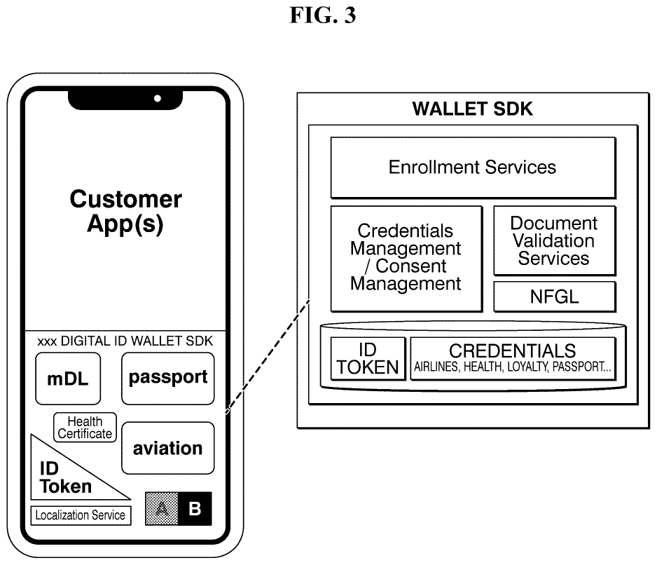

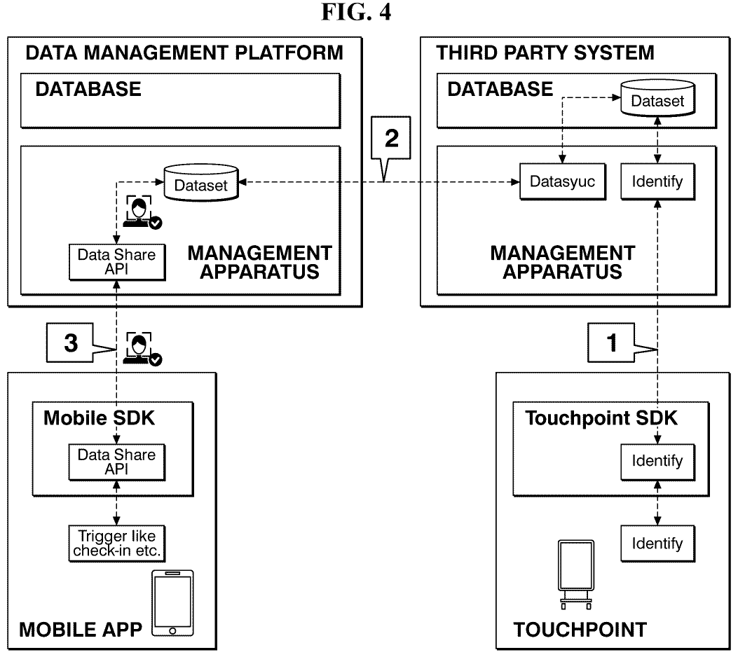

FIG. 3 illustrates a mobile application according to an example embodiment. According to an example embodiment, the mobile application may be compatible with various platforms, including, but not limited to android and iOS devices. According to an example embodiment, the mobile application may include a digital wallet SDK or a digital wallet feature, which allows a user to manage the DID, and credentials in an efficient and smooth manner. For example, the digital wallet SDK may provide mechanisms to store, manage and use digital signature, document credentials (such as driver's license and passport), health certificates (such as vaccination cards), and membership information (such as gym membership or amusement park membership). However, the disclosure is not limited thereto, and as such, the digital wallet SDK is capable of managing other types of documents and information as well. For example, the digital wallet SDK is capable of managing flight itinerary or other event details.

According to an example embodiment, the digital wallet may be further configured to manage credentials of another person related to the user of the mobile device. For example, a parent may perform document credential processes and data share processes for a child using the mobile application of the parent, and store the credentials in the digital wallet of the parent.

According to an example embodiment, the mobile application may provide other features, including but not limited to, APIs for mobile application integration, enrollment services including face enrollment, document validation, content management, backed end matching and a highly scalable facial recognition algorithm, which provide fast and accurate results for real-time or post-event facial recognition use cases.

FIG. 4 is a schematic diagram illustrating a configuration of a decentralized identifier (DID) management system according another example embodiment. According to this example embodiment, a third party system may be further provided to perform one or more operations of the account creation process, document credential process and the data share process. For example, a management apparatus or a server of the third party system may perform one or more of the functions performed by the management apparatus 2 illustrate in FIG. 1. Accordingly, the DID system according to one or more example embodiments of the disclosure may provide a domain agnostic implementation that allows data share request to be resolved by the targeted dataset(s) as per tenant configuration.

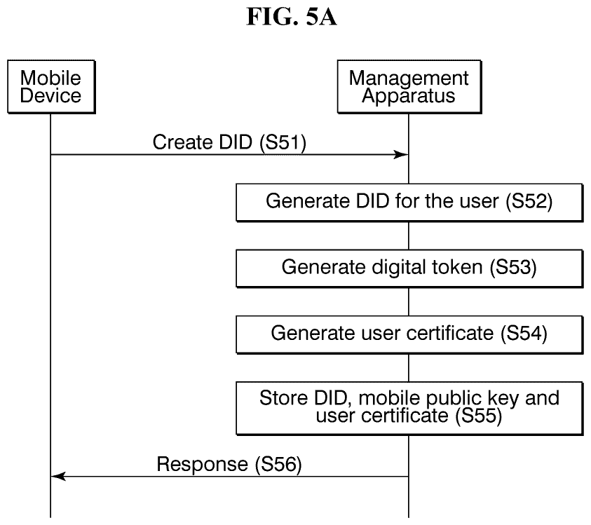

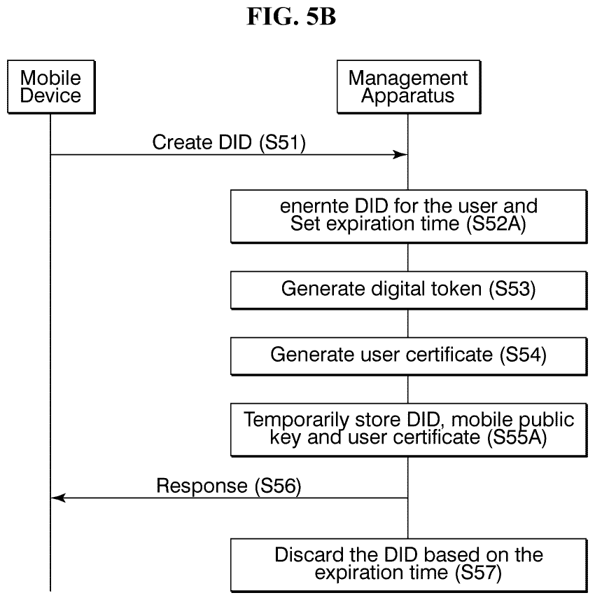

FIG. 5A is a flow chart illustrating an account creation process according to an example embodiment. According to an example embodiment, when an account creation is selected, for example by a user, the mobile app may initiate the account creation process 100. According to an example embodiment, in operation S51, the mobile device may send a create DID request to the management apparatus. According to an example embodiment, the create DID request may include an image and a public key to the management apparatus. According to an example embodiment, the user provides an image to be included in the account creation. For example, the mobile app may prompt the user to take a selfie image. According to an example embodiment, the mobile device or the mobile app may obtain or produce the public key by generating a RSA key pair.

According to an example embodiment, the management apparatus may receive the image and the public key. According to an example embodiment, in operation S52, the management apparatus may generate a decentralized identifier (DID) after validating the public key and the image included in the create request. Moreover, in operation S53, the management apparatus may generate a digital token. According to an example embodiment, the digital token may include the DID, the image, a proof and a credential type. Furthermore, in operation S54, the management apparatus may generate a user certificate. According to an example embodiment, the user certificate may include information for performing subsequent DID transactions by the mobile app.

According to an example embodiment, in operation S55, the management apparatus may store the DID, the public key and the user certificate. According to an example embodiment, the management apparatus may send a response, which include the DID, the user certificate and the digital token.

According to an example embodiment, in operation S56, the mobile device may receive a response message from the management apparatus. According to an example embodiment, the response message may include a digital token credential along with a DID, and a user certificate.

Although FIG. 5A illustrates an example embodiment of the account creation process, the disclosure is not limited to the order or the sequence of operations illustrated in FIG. 5A. As such, according to other example embodiment additional operations may be included or operations may be removed the process illustrated in FIG. 5A without deviating from the spirit of the disclosure.

FIG. 5B is a flow chart illustrating an account creation process according to another example embodiment. Detailed description for operations S51, S53, S54 and S56 may be same as the description in FIG. 5A, and as such, the repeated description is omitted.

According to an example embodiment, in operation S51, the mobile device may send a create DID request to the management apparatus. According to an example embodiment, in operation S52A, the management apparatus may generate a decentralized identifier (DID) after validating the public key and the image included in the create request. In addition, according to an example embodiment, the management apparatus may set an expiration time. According to an example embodiment, the expiration time may include a data and a time at which the DID is discarded from the management apparatus. According to an example embodiment, the expiration date and time may be selected by the user using the mobile wallet SDK and set to the management apparatus. However, the disclosure is not limited thereto, and as such, according to another example embodiment, the management apparatus may locally generate the data and time. According to an aspect of the disclosure, the user self manages and stores sensitive information locally on the mobile device using application such as mobile wallet SDK in a decentralized manner. Therefore, the management apparatus does not centrally store or manage user information. In this manner, security and privacy of the user data is further improved.

According to an example embodiment, in operation S53, the management apparatus may generate a digital token, and in operation S54, the management apparatus may generate a user certificate. According to an example embodiment, in operation S55A, the management apparatus may temporarily store the DID, the public key and the user certificate, and transmit a response message S56 to the mobile device. According to an example embodiment, in operation S56, the mobile device may receive a response message from the management apparatus.

According to an example embodiment, in operation S57, upon a determination that the expiration date and time has reached, the management apparatus may discard the DID. However, the disclosure is not limited thereto, and as according to an example embodiment, the management apparatus may discard other information related to the transaction with user that may have been temporarily stored in the management apparatus or in the back end.

Although FIG. 5B illustrates an example embodiment of the account creation process, the disclosure is not limited to the order or the sequence of operations illustrated in FIG. 5B. As such, according to other example embodiment additional operations may be included or operations may be removed the process illustrated in FIG. 5B without deviating from the spirit of the disclosure.

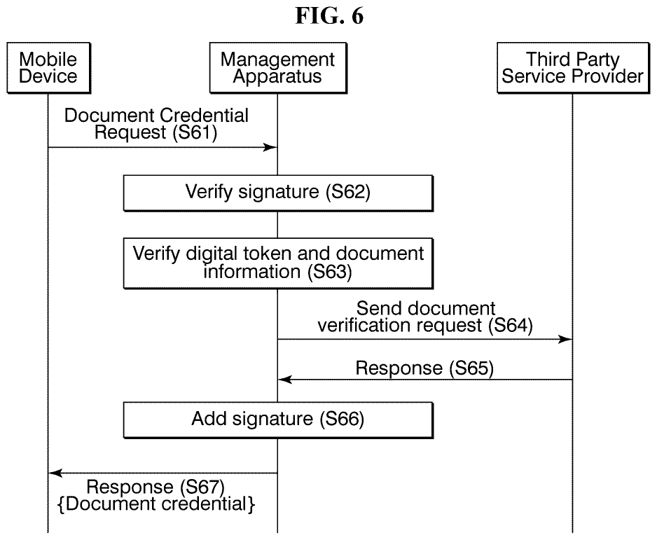

FIG. 6 is a flow chart illustrating a document credential process according to an example embodiment. According to an example embodiment, after the DID is generated and sent to the mobile device, the management apparatus may allow the user to digitize the identity documents by issuing a verifiable credential (VC) encapsulating all the information available on the document.

According to the example embodiment, in operation S61, the mobile device may send a document credential request to the management apparatus. According to an example embodiment, before sending the document credential request, the mobile apparatus may extract and/or verify data from a scanned document to which a document credential is requested. For example, the document may include, but is not limited to, a driver's license, a passport, and a vaccination card.

The document credential request may include a digital token, a type of document, credential subject and a proof. According to an example, the mobile device may create a JSON Web Signature (JWS) by signing the credential subject and the type of document using a private key portion of the RSA key pair. According to an example embodiment, the credential subject may include document information and cropped image scanned from the document. Also, the document information may be information extracted from the document.

According to an example embodiment, the mobile app may assemble the request payload for the document credential with the credential subject, the type of the document, the digital token credential and a proof that includes the JWS and send the request payload to the management apparatus in operations S61.

According to an example embodiment, the request payload for document credential request may be similar to the payload for creating the account, except the request payload may be signed with the private key that is paired with the public key shared in payload for creating the payload, and the JWS is added in the proof of the request.

According to an example embodiment, in operation S62, the management apparatus may verify the signature. According to an example embodiment, the management apparatus may verify the signature (JWS) in the proof of the request using the public key associated with the DID.

According to an example embodiment, in operation S63, the management apparatus may verify the digital token and the document information. For example, the digital token credential may also be included in the document credential request payload, since the management apparatus may perform a one to one (1:1) verification with the selfie image (from the account creation process) and the document's cropped image. After the proof verification and the verification of the digital token and the document information is successfully completed, in operation S66, the management apparatus may create the document credential with the same credential subject, and sign it with a private key of the management apparatus, and return the document credential in a response to the mobile device.

However, the disclosure is not limited thereto, and as such, according to an example embodiment, in operation S64, the management apparatus may send a document verification request to a third party service provider. For example, if a document to be verified is a driver's license or a passport, the management apparatus may send a document verification request with the relevant document information to an appropriate third party service provider for verification of the document. For example, in case of a driver's license or a passport, the management apparatus may transmit the document to an authority, which issues driver's licenses or passports for further verification.

According to an example embodiment, in operation S65, the management apparatus receives a response from the third party service provider. According to an example embodiment, the response may indicate if there is a match or not.

According to an example embodiment, when there is a match, in operation S66, the management apparatus may add signature to the credential subject and the type of document and create a document credential and send to the mobile device.

According to an example embodiment, in operation S67, the mobile device may receive a response including the document credential from the management apparatus.

According to an example embodiment, if any of the verification operations S62 or S63 is unsuccessful, and error message may be sent to the mobile device.

According to an example embodiment, the operations for creating document credentials may include creating an object containing credential subject, digital token credential and type. For example, in case the document is driver's license, the credential type will be driver's license. Furthermore, according to an example embodiment, the mobile device may serialize this object to JSON String in alphabetical order. According to an example embodiment, the mobile device may generate a signature using private key portion of the same RSA key pair that was described above id the discussed related to the account creation process. According to an example embodiment, the mobile device may generate a Base64 encoded string from the resulted bytes of previous operation and sign it using “SHA256withRSA” algorithm. Although a method of creating the document credentials is described according to an example, embodiment, the disclosure is not limited thereto, and as such, according to another example embodiment, a different method of creating the document credentials may be implemented.

According to an example embodiment, the management apparatus (or a back end system) may perform the same operations to create credential proof except that the private key will belong to the management apparatus' RSA keypair and management apparatus will use management apparatus's public key to verify the management apparatus' issued credential. Moreover, the management apparatus may also perform similar operations for proof verification of verifiable credential and verifiable presentation requests by using the public key that was shared in create account request.

Although FIG. 6 illustrates an example embodiment of the data credential process, the disclosure is not limited to the order or the sequence of operations illustrated in FIG. 6. As such, according to other example embodiment additional operations may be included or operations may be removed the process illustrated in FIG. 6 without deviating from the spirit of the disclosure.

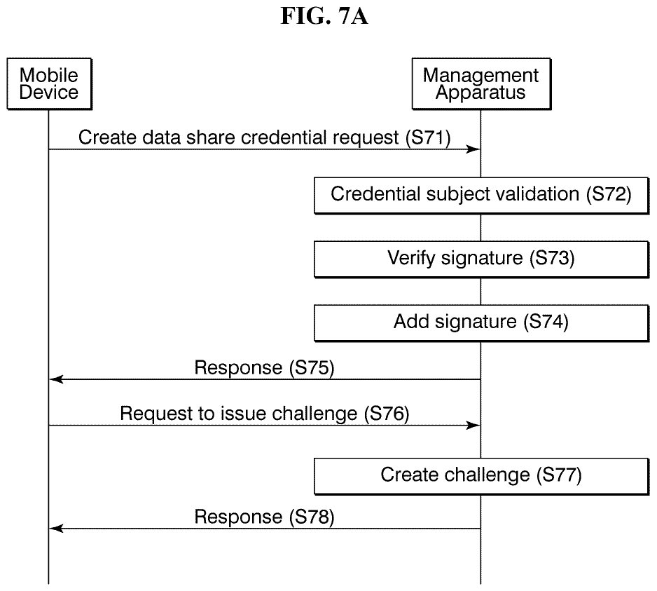

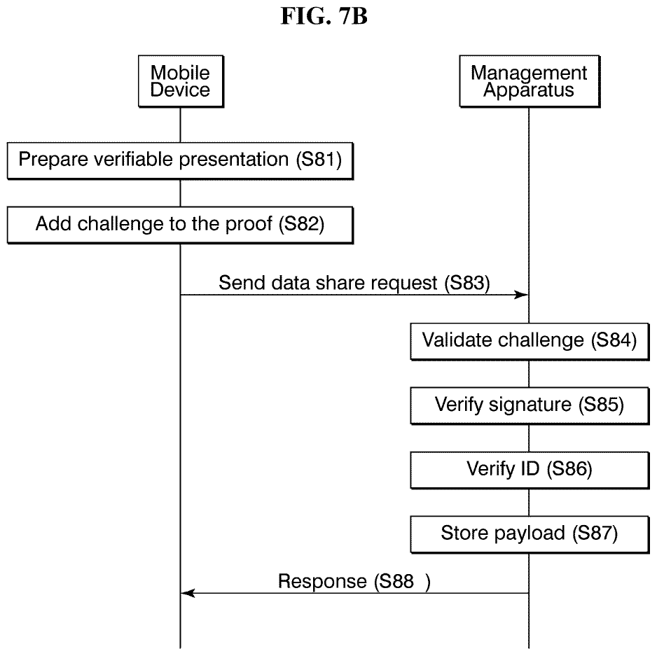

FIGS. 7A and 7B are flow charts illustrating a data share process according to an example embodiment.

According to an example embodiment, the data share process 200 may be triggered by an event, such as a check-in event or may be triggered by a user input. However, the disclosure is not limited thereto, and as such various other events may trigger the data share process 200.

Referring to FIGS. 7A and 7B, according to an example embodiment, the data share process may include creating a data share credential request (operations S71 to S75), fetching a challenge from the management apparatus (operations S76 to S78), and creating the data share request (operations S81 to S88). According to an example embodiment, the data share credential may be a temporary credential that provides event details that subsequently helps the management apparatus (or the backend) to resolve a targeted dataset. According to an example embodiment, the event details may be tenant specific configurations. According to an example embodiment, the mobile device may store keys of the event details and the corresponding metadata in a local configuration of the mobile device. However, the disclosure is not limited thereto, and as such, the keys of the event details and/or the corresponding metadata may be stored in a different manner.

According to an example embodiment, in operation S71, the mobile device may create a data share credential request. The data share credential request payload may include a credential subject, which may include event details, and metadata. According to an example embodiment, the credential subject may include DID.

According to an example embodiment, upon receiving the data share credential request payload, in operation S72, the management apparatus may perform credential subject validation. Moreover, in operation S73, the management apparatus may look up public key associated with the DID included in the data share credential request payload subject and verify signature. If the signature is verified as valid, in operation S74, the management apparatus may sign the credential subject using a private key of the management apparatus. However, if the signature is not verified, the management apparatus may return and error message.

According to an example embodiment, after obtaining the data share credential, in operation S76, the mobile device may send a request to the management apparatus to issue a challenge. The request may include a DID for which the challenge is desired. According to an example embodiment, in operation S77, the management apparatus may issue a challenge and send to the mobile device. According to an example embodiment, in operation S78, the mobile device may receive the challenged. According to an example embodiment, the challenge may be JWT with a limited expiry, and the challenge may be associated with the DID provided in the request for issuance of the challenge. According to an example embodiment, the management apparatus may issue a challenge with an expiration to avoid replay attacks, and as such the challenge may be mandatory to be part of proof in the data share request.

According to an example embodiment, the data share request may also be referred to as a verifiable presentation (VP). According to an example embodiment, in operation S81, the mobile device may prepare verifiable presentation data using the data share credentials and challenge. According to an example, the verifiable presentation may include the mobile device creating a JSON Web Signature (JWS), to be included in the proof, by signing the digital token, data share credential, one or more document credentials, and a credential subject and a type of document using a private key portion of the RSA key pair. According to an example embodiment, in operation S82, the mobile device may include the challenge in the proof. Thereafter, in operation S83, the mobile device may invoke a data share API and send a payload including verifiable presentation, and user certificate. However, the disclosure is not limited thereto, and as such, the payload may further include a target system, which may be a third party system for resolving the verifiable presentation.

According to an example embodiment, upon receiving the data share request payload, the management apparatus may validate the challenge (in operation S84), verify the signature (in operation S85), and verify if ID in the credential subject matches with the verifiable presentation proof (in operation S86). If any of these verifications/validations fail, an error message is transmitted to the mobile device. According to an example embodiment, in operation S87, the data share request payload may be stored in a local database of the management apparatus. According to an example embodiment, the management apparatus may send a response S88 indicating a number of save data share payload.

According to an example embodiment, the management apparatus may share the credential subject (including face image) with the target system. According to an example embodiment, the target system may be identity management service of the management apparatus. However, the disclosure is not limited thereto, and as such, the target system may be a third party system. According to an example embodiment, a target dataset will be resolved by comparing the system/tenant configuration of the target system and the payload shared by mobile device.

Although FIGS. 7A-7E illustrate example embodiments of the data share process, the disclosure is not limited to the order or the sequence of operations illustrated in FIGS. 7A-7E. As such, according to other example embodiment additional operations may be included or operations may be removed the process illustrated in FIGS. 7A-7E without deviating from the spirit of the disclosure.

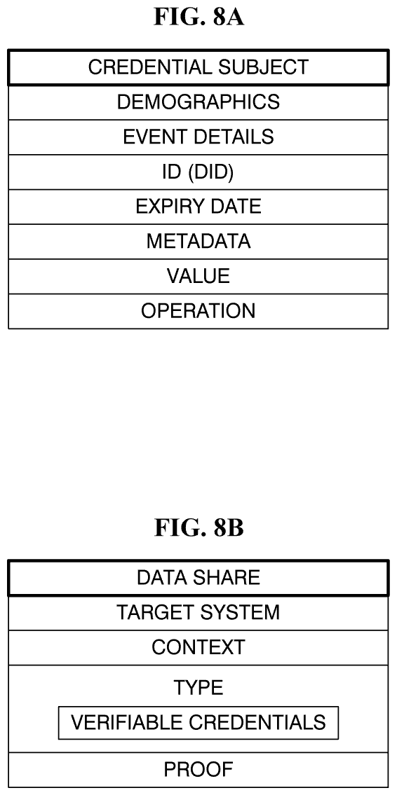

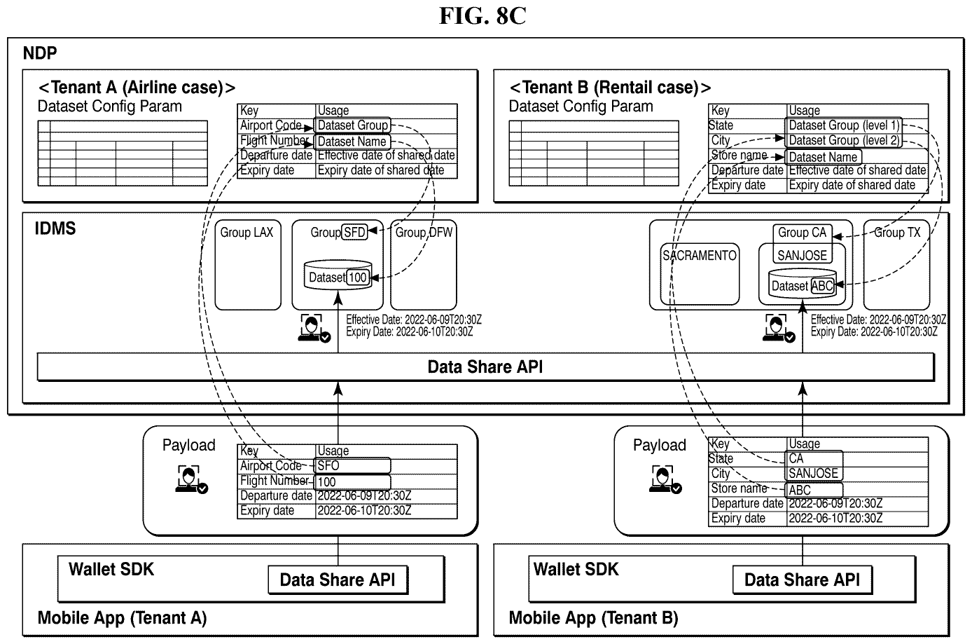

FIGS. 8A, 8B and 8C are diagrams illustrating examples of a data share process according to example embodiments.

According to an example embodiment, FIG. 8A illustrates a sample data share credential subject. According to this example embodiment, flight details are provided as event details data, but the disclosure is not limited thereto, and as such, other data may be provide as event details data.

According to an example embodiment, FIG. 8B illustrates a sample data share request. According to this example embodiment, both passport and driver's license credentials are provided as verifiable credentials (or document credentials), but the disclosure is not limited thereto, and as such, other data may be provided. For example, the DID management system according to an example embodiment may allow for provision of selective details from the verifiable credentials. For example, the mobile app may allow a user to choose or select, which elements or portions of a verifiable credential are to be shared, instead of sharing the entire verifiable credentials during the data share request. In order to facilitate the selectable sharing, BBS+ signature may be implemented, which provides selective disclosures controlled completely by the holder where every field in the verifiable credential has a signature. As such, the verifiable credential itself becomes a compilation of individual signatures, one for each field. For example, in a scenario, in which, an age verification is necessary (e.g., to buy age restricted products), the user may able to select and share only the age information portion (e.g., field) of the verifiable credential may be shared with a vendor instead of sharing all the information in the verifiable credential. Accordingly, the DID management system provides for further security and privacy but further limiting unnecessary sharing of sensitive data.

According to an example embodiment, FIG. 8C illustrates an example of how the target data set of the data share is resolved according to target system and tenant configuration. According to the example, Tenant A may be an airline service provided and Tenant B may be a retail service provider. As such, when a data share request is created corresponding to Tenant A, the payload may include airline code, flight number, departure data and expiry data, which will be resolved by the target dataset according to the configuration of Tenant A. On the other hand, when a data share request is created corresponding to Tenant B, the payload may include city, state, store name and expiry date, which will be resolved by the target dataset according to the configuration of Tenant B.

Accordingly, a user of the DID management system can selectively provide data share to various tenants with ease, while managing the private and sensitive data in a self-controlled manner.

According to an example embodiment, the DID management system may include a feature to revoke the DID. For example, the user of the mobile device may be able to select a revoke option to either revoke the entire DID or revoke a particular data share request. Moreover, according to an example embodiment, the user may be able to selectively revoke an individual verifiable credential or a document credential, such that any future authentication (data share) request that includes the revoked verifiable credential or the document credential will be rejected. In this manner, the user is provided with a capability manage the private and sensitive data in an improved manner. According to another example embodiment, the management apparatus may also be capable of revoking the verifiable credential or the document credential, the DID and or a particular data share.

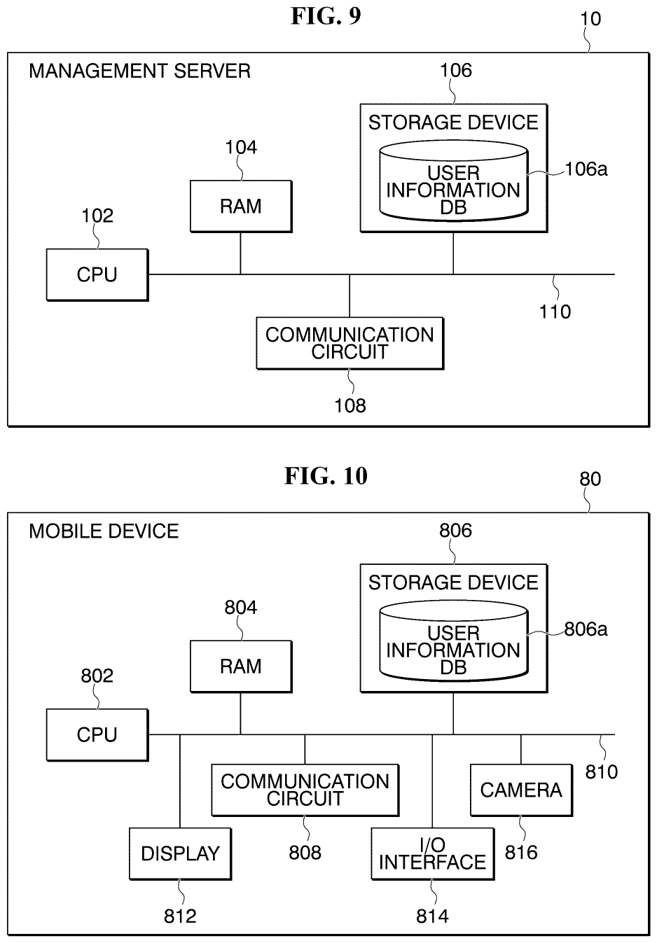

FIG. 9 illustrates a block diagram of the management apparatus according to an example embodiment. As depicted in FIG. 9, and described below, the management apparatus may be implemented as a server 10. However, the disclosure is not limited to a server, and as such, the management apparatus may be another type of device configured to perform DID management processes.

According to an example embodiment, the management server 10 may include a CPU 102, a RAM 104, a storage device 106, and a communication circuit 108. The CPU 102, the RAM 104, the storage device 106, and the communication circuit 108 are connected to a bus line 110.

The CPU 102 may function as a controller that operates by executing a program stored in the storage device 106 and controls the operation of the entire management server 10. According to an example embodiment, the CPU 102 may function as an orchestration layer that orchestrates the interactions between the front end components of the mobile device 80, and the backend DID management infrastructures, such as accessing databases or communication with third party systems. Further, the CPU 102 executes an application program stored in the storage device 106 to perform various processes as the management server 10. The RAM 104 provides a memory field necessary for the operation of the CPU 102.

More specifically, the CPU 102 may receive a request for creating a decentralized identification (DID) information to an external device and transmit the DID information along with a digital token credential and a user certificate from the external device. The request may include an image of a user and a public key of the external device.

According to an example embodiment, the CPU 102 may receive a document credential request to the external device, the document credential request comprising a credential subject, a type of document, the digital token credential and a proof that comprises a signature; and transmit a document credential from the external device.

According to an example embodiment, the CPU 102 may perform verification based on the digital token credential and the credential subject; perform verification of the signature in the proof of the document credential request using a public key associated with the DID; based on a verification of the proof being successful, create the document credential with the credential subject, sign the document credential with a private key of the apparatus, and transmit the document credential to the external device.

According to an example embodiment, the CPU 102 may receive a data share credential request from the external device; transmit a data share credential to the external device; receive an issue challenge request from the external device; transmit a challenge to the external device; receive a data share request created using the data share credential and challenge; and transmit a verification success or failure based on verification of information in the data share request.

FIG. 10 illustrates a block diagram of the features of the mobile device 80 according to an example embodiment. For instance, the mobile device 80 has a central processing unit (CPU) 802, a random access memory (RAM) 804, a storage device 806, a communication circuit 808, a display 812, an input/output (I/O) interface 814 and a camera 816, which may be connected to a bus line 810. According to an example embodiment, the mobile device may include some or all of the features in the mobile application illustrated in FIG. 3

According to an example embodiment, the CPU 802 functions as a controller that operates by executing a program stored in the storage device 806 and controls the operation of the mobile device 80. Further, the CPU 802 executes an application program stored in the storage device 806 to perform various processes as the mobile device 80. The RAM 804 provides a memory field necessary for the operation of the CPU 802.

According to an example embodiment, the communication circuit 808 may include a transceiver configured to transmit and receive data from one or more devices external to the mobile device. According to an example embodiment, the communication circuit 808 may perform wireless communication. According to an example embodiment, the display 812 may display information on the display. According to an example embodiment, the display may include a touch screen for receiving a touch input. According to an example embodiment, the input/output (I/O) interface 814 may include microphone and speakers to receive audio input and output audio output. According to an example embodiment, the camera 816 may capture one or more images.

According to an example embodiment, the CPU 802 may obtain an image of a user; obtain a public key of the apparatus; transmit a request for creating a decentralized identification (DID) information to an external device; and receive the DID information along with a digital token credential and an user certificate from the external device. According to an example, embodiment, the image may be a selfie image of the user captured by the camera 816. According to an example embodiment, the image may be receive through the communication circuit 808. The public key may be obtained by generating an RSA key pair and the digital token credential may be signed by a private key of the external device.

According to an example embodiment, the CPU 802 may transmit a document credential request to the external device; and receive a document credential from the external device. According to an example embodiment, the CPU 802 may create a signature by signing a credential subject and a type of document using a private key portion of an RSA key pair; assemble the document credential request with the credential subject, the type of the document, the digital token credential and a proof that comprises the signature; and transmit the document credential request to the external device. The signature may be a JSON Web Signature (JWS), the credential subject may include at least one of document information and an image scanned from a document, the credential subject may include at least one of document information and an image scanned from a document, and the document may be one of a driver's license, a passport, or a vaccination card.

According to an example embodiment, the CPU 802 may transmit a data share credential request to the external device; receive a data share credential from the external device; transmit an issue challenge request to the external device; receive a challenge from the external device; create a data share request using the data share credential and challenge; and transmit the data share request to the external device. The data share credential request may include a credential subject, which comprises event details, and metadata corresponding to the event details and the challenge may include an expiration time, and the challenge is associated with the DID information.

The disclosure is not limited to the example embodiments described above but can be changed as appropriate within a range not departing from the spirit of the disclosure. For instance, although the example embodiments illustrate the mobile device and the management server being used in connection with an airline service provide or a retail service provided, the disclosure is not limited thereto. For instance, according to another example embodiment, the mobile device and/or the management server may be used in any facility, such as mass transit facilities, tourist attractions, amusement parks, museums, supermarkets etc., which require authentication or authorization of a user to use the service provided the facility.

The scope of one or more example embodiments also includes a processing method of storing, in a storage medium, a program that causes the configuration of the example embodiment to operate to implement the function of the example embodiment described above, reading out as a code the program stored in the storage medium, and executing the code in a computer. That is, a computer readable storage medium is also included in the scope of each example embodiment. Further, not only the storage medium in which the program described above is stored but also the program itself is included in each example embodiment. Further, one or more components included in the example embodiments described above may be a circuit such as an Application Specific Integrated Circuit (ASIC), a Field Programmable Gate Array (FPGA), or the like configured to implement the function of each component.

As the storage medium, for example, a floppy (registered trademark) disk, a hard disk, an optical disk, a magneto-optical disk, a Compact Disk (CD)-ROM, a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

The service implemented by the function of one or more example embodiments described above can be provided to the user in a form of Software as a Service (Saas).

Note that all the example embodiments described above are mere examples of embodiments in implementing the disclosure, and the technical scope of the disclosure should not be construed in a limiting sense by these example embodiments. That is, the disclosure can be implemented in various forms without departing from the technical concept thereof or the primary feature thereof.

A part or all of the exemplary embodiment described above can be written as in the supplementary notes below, but is not limited thereto.

### Supplementary Note 1

An apparatus comprising:
a memory storing one or more instructions; and
a processor configured to execute the one or more instructions to:
   obtain an image of a user;
   obtain a public key of the apparatus;
   transmit a request for creating a decentralized identification (DID) information to an external device; and
   receive the DID information along with a digital token credential and an user certificate from the external device.

### Supplementary Note 2

The apparatus of supplementary note 1, wherein the image is a selfie image of the user, the public key is obtained by generating an RSA key pair and the digital token credential is signed by a private key of the external device.

### Supplementary Note 3

The apparatus of supplementary note 1, wherein the processor is further configured to:
transmit a document credential request to the external device; and
receive a document credential from the external device.

### Supplementary Note 4

The apparatus of supplementary note 3, wherein the processor is further configured to:
create a signature by signing a credential subject and a type of document using a private key portion of an RSA key pair;
assemble the document credential request with the credential subject, the type of the document, the digital token credential and a proof that comprises the signature; and
transmit the document credential request to the external device.

### Supplementary Note 5

The apparatus of supplementary note 4, wherein the signature is a JSON Web Signature (JWS), the credential subject comprises at least one of document information and an image scanned from a document and the document is one of a driver's license, a passport, or a vaccination card.

### Supplementary Note 6

The apparatus of supplementary note 1, wherein the processor is further configured to:
transmit a data share credential request to the external device;
receive a data share credential from the external device;
transmit an issue challenge request to the external device;
receive a challenge from the external device;
create a data share request using the data share credential and challenge; and
transmit the data share request to the external device.

### Supplementary Note 7

The apparatus of supplementary note 6, wherein the data share credential request comprises a credential subject, which comprises event details, and metadata corresponding to the event details and the challenge comprises an expiration time, and the challenge is associated with the DID information.

### Supplementary Note 8

A decentralized identity management method comprising:
obtaining, by an electronic device, an image of a user and a public key;
transmitting, by the electronic device, a request for creating a decentralized identification (DID) information to an external device; and
receiving, by the electronic device, the DID information along with a digital token credential and an user certificate from the external device.

### Supplementary Note 9

The method of supplementary note 8, wherein the image is a selfie image of the user, the public key is obtained by generating an RSA key pair and the digital token credential is signed by a private key of the external device.

### Supplementary Note 10

The method of supplementary note 8, further comprising:
transmitting a document credential request to the external device; and
receiving a document credential from the external device.

### Supplementary Note 11

The method of supplementary note 10, further comprising:
creating a signature by signing a credential subject and a type of document using a private key portion of an RSA key pair;
assembling the document credential request with the credential subject, the type of the document, the digital token credential and a proof that comprises the signature; and
transmitting the document credential request to the external device.

### Supplementary Note 12

The method of supplementary note 11, wherein the signature is a JSON Web Signature (JWS), the credential subject comprises at least one of document information and an image scanned from a document and the document is one of a driver's license, a passport, or a vaccination card.

### Supplementary Note 13

The method of supplementary note 11, further comprising:
transmitting a data share credential request to the external device;
receiving a data share credential from the external device;
transmitting an issue challenge request to the external device;
receiving a challenge from the external device;
creating a data share request using the data share credential and challenge; and
transmitting the data share request to the external device.

### Supplementary Note 14

The method of supplementary note 13, wherein the data share credential request comprises a credential subject, which comprises event details, and metadata corresponding to the event details and the challenge comprises an expiration time, and the challenge is associated with the DID information.

### Supplementary Note 15

A decentralized identity management method comprising:
receiving a request for creating a decentralized identification (DID) information to an external device, the request including an image of a user and a public key of the external device; and
transmitting the DID information along with a digital token credential and an user certificate to the external device.

### Supplementary Note 16

The method of supplementary note 15, further comprising:
setting an expiration time; and
discarding a temporarily stored copy of the DID at the expiration time.

### Supplementary Note 17

The method of supplementary note 15, further comprising:
receiving a document credential request to the external device, the document credential request comprising a credential subject, a type of document, the digital token credential and a proof that comprises a signature; and
transmitting a document credential from the external device.

### Supplementary Note 18

The method of supplementary note 17, further comprising:
performing verification based on the digital token credential and the credential subject;
performing verification of the signature in the proof of the document credential request using a public key associated with the DID;
based on a verification of the proof being successful, creating the document credential with the credential subject;
signing the document credential with a private key of a management apparatus; and
transmitting the document credential to the external device.

### Supplementary Note 19

The method of supplementary note 17, wherein the signature is a JSON Web Signature (JWS), the credential subject comprises at least one of document information and an image scanned from a document and the document is one of a driver's license, a passport, or a vaccination card.

### Supplementary Note 20

The method of supplementary note 15, further comprising:
receiving a data share credential request from the external device;
transmitting a data share credential to the external device;
receiving an issue challenge request from the external device;
transmitting a challenge to the external device;
receiving a data share request created using the data share credential and challenge; and
transmitting a verification success or failure based on verification of information in the data share request, and
wherein the data share credential request comprises a credential subject, which comprises event details, and metadata corresponding to the event details and the challenge comprises an expiration time, and the challenge is associated with the DID information.

1. An apparatus comprising:
a memory storing one or more instructions; and
a processor configured to execute the one or more instructions to:
obtain an image of a user;
obtain a public key of the apparatus;
transmit a request for creating a decentralized identification (DID) information to an external device; and
receive the DID information along with a digital token credential and an user certificate from the external device.

2. The apparatus of claim 1, wherein the image is a selfie image of the user, the public key is obtained by generating an RSA key pair and the digital token credential is signed by a private key of the external device.

3. The apparatus of claim 1, wherein the processor is further configured to:
transmit a document credential request to the external device; and
receive a document credential from the external device.

4. The apparatus of claim 3, wherein the processor is further configured to:
create a signature by signing a credential subject and a type of document using a private key portion of an RSA key pair;
assemble the document credential request with the credential subject, the type of the document, the digital token credential and a proof that comprises the signature; and
transmit the document credential request to the external device.

5. The apparatus of claim 4, wherein the signature is a JSON Web Signature (JWS), the credential subject comprises at least one of document information and an image scanned from a document and the document is one of a driver's license, a passport, or a vaccination card.

6. The apparatus of claim 1, wherein the processor is further configured to:
transmit a data share credential request to the external device;
receive a data share credential from the external device;
transmit an issue challenge request to the external device;
receive a challenge from the external device;
create a data share request using the data share credential and challenge; and
transmit the data share request to the external device.

7. The apparatus of claim 6, wherein the data share credential request comprises a credential subject, which comprises event details, and metadata corresponding to the event details and the challenge comprises an expiration time, and the challenge is associated with the DID information.

8. A decentralized identity management method comprising:
obtaining, by an electronic device, an image of a user and a public key;
transmitting, by the electronic device, a request for creating a decentralized identification (DID) information to an external device; and
receiving, by the electronic device, the DID information along with a digital token credential and an user certificate from the external device.

9. The method of claim 8, wherein the image is a selfie image of the user, the public key is obtained by generating an RSA key pair and the digital token credential is signed by a private key of the external device.

10. The method of claim 8, further comprising:
transmitting a document credential request to the external device; and
receiving a document credential from the external device.

11. The method of claim 10, further comprising:
creating a signature by signing a credential subject and a type of document using a private key portion of an RSA key pair;
assembling the document credential request with the credential subject, the type of the document, the digital token credential and a proof that comprises the signature; and
transmitting the document credential request to the external device.

12. The method of claim 11, wherein the signature is a JSON Web Signature (JWS), the credential subject comprises at least one of document information and an image scanned from a document and the document is one of a driver's license, a passport, or a vaccination card.

13. The method of claim 11, further comprising:
transmitting a data share credential request to the external device;
receiving a data share credential from the external device;
transmitting an issue challenge request to the external device;
receiving a challenge from the external device;
creating a data share request using the data share credential and challenge; and
transmitting the data share request to the external device.

14. The method of claim 13, wherein the data share credential request comprises a credential subject, which comprises event details, and metadata corresponding to the event details and the challenge comprises an expiration time, and the challenge is associated with the DID information.

15. A decentralized identity management method comprising:
receiving a request for creating a decentralized identification (DID) information to an external device, the request including an image of a user and a public key of the external device; and
transmitting the DID information along with a digital token credential and an user certificate to the external device.

16. The method of claim 15, further comprising:
setting an expiration time; and
discarding a temporarily stored copy of the DID at the expiration time.

17. The method of claim 15, further comprising:
receiving a document credential request to the external device, the document credential request comprising a credential subject, a type of document, the digital token credential and a proof that comprises a signature; and
transmitting a document credential from the external device.

18. The method of claim 17, further comprising:
performing verification based on the digital token credential and the credential subject;
performing verification of the signature in the proof of the document credential request using a public key associated with the DID;
based on a verification of the proof being successful, creating the document credential with the credential subject;
signing the document credential with a private key of a management apparatus; and
transmitting the document credential to the external device.

19. The method of claim 17, wherein the signature is a JSON Web Signature (JWS), the credential subject comprises at least one of document information and an image scanned from a document and the document is one of a driver's license, a passport, or a vaccination card.

20. The method of claim 15, further comprising:
receiving a data share credential request from the external device;
transmitting a data share credential to the external device;
receiving an issue challenge request from the external device;
transmitting a challenge to the external device;
receiving a data share request created using the data share credential and challenge; and
transmitting a verification success or failure based on verification of information in the data share request, and
wherein the data share credential request comprises a credential subject, which comprises event details, and metadata corresponding to the event details and the challenge comprises an expiration time, and the challenge is associated with the DID information.
